(19) United States
(12) Patent Application Publication
(10) Pub. No.: US 2017/0309101 A1
(43) Pub. Date: Oct. 26, 2017

(54) ELECTRONIC KEY

(71) Applicant: KABUSHIKI KAISHA TOKAI RIKA DENKI SEISAKUSHO, Aichi (JP)

(72) Inventors: Daisuke SENZAKI, Aichi (JP); Yuki KONO, Aichi (JP); Masayuki KAWAMURA, Aichi (JP); Hiroaki KOJIMA, Aichi (JP)

(21) Appl. No.: 15/531,888

(22) PCT Filed: Nov. 26, 2015
(86) PCT No.: PCT/JP2015/083204

§ 371 Date: May 31, 2017

(30) Foreign Application Priority Data
Dec. 2, 2014 (JP) 2014-243925

(51) Int. Cl. G07C 9/00; H01M 2/10; H01M 10/42; B60R 25/01; B60R 25/24; B60R 25/20; E05B 19/00

(52) U.S. Cl. CPC G07C 9/00944; H01M 10/425; H01M 2/1044; B60R 25/01; E05B 19/00; B60R 25/241; B60R 25/209; G07C 2009/00984; H01M 2220/30; G07C 2009/00587

(57) ABSTRACT

An electronic key includes a housing including a battery housing portion that houses a battery, the battery housing portion being provided in the housing, a battery terminal, arranged within the battery housing portion, that makes contact with one electrode of the battery housed within the battery housing portion, and a board, arranged within the battery housing portion, including a first conductive portion that makes contact with the battery terminal and is electrically connected to the one electrode of the battery via the battery terminal, and a second conductive portion that makes contact with and is electrically connected to another electrode of the battery.

### TECHNICAL FIELD

The present invention relates to an electronic key.

### BACKGROUND ART

A portable device for an electronic key system is known, where a circuit board on which a communication circuit for wirelessly communicating with the exterior is mounted, a protective cover placed over one surface of the circuit board, and a plate-shaped battery holder that is placed over the other surface of the circuit board and that holds a battery, are housed within a case forming the outer form of a portable device main body (see Patent Document 1, for example).

In the portable device disclosed in Patent Document 1, a positive terminal that contacts the positive electrode of the battery and a negative terminal that contacts the negative electrode of the battery are provided in the circuit board. With this portable device, when a battery is inserted into the battery holder of the portable device, elastic force of the positive terminal and the negative terminal ensure that a conductive path is formed between the battery and the communication circuit.

### CITATION LIST

### Patent Document

Patent Document 1: Japanese Unexamined Patent Application Publication No. 2008-196194A

### SUMMARY OF INVENTION

### Technical Problem

In the portable device disclosed in Patent Document 1, the positive terminal is attached to the circuit board so as to be erected from the circuit board. As such, when the battery is inserted, a load is applied on a part where the positive terminal and the circuit board are connected. Conduction problems may arise as a result. Furthermore, the negative terminal is arranged substantially parallel to a front surface of the circuit board, and thus to maintain a connection with the battery, a configuration is required to be employed in which the circuit board is sandwiched to produce a force that presses the battery against the negative terminal. Such a configuration is problematic in that the device has many components and is difficult to be assembled.

An object of the present invention is to provide an electronic key electronic key that suppresses conduction problems between a battery and a circuit while having improved ease of assembly.

### Solution to Problem

An electronic key according to an embodiment of the present invention includes: a housing including a battery housing portion that houses a battery, the battery housing portion being provided in the housing; a battery terminal, arranged within the battery housing portion, that makes contact with one electrode of the battery housed within the battery housing portion; and a board, arranged within the battery housing portion, including a first conductive portion that makes contact with the battery terminal and is electrically connected to the one electrode of the battery via the battery terminal, and a second conductive portion that makes contact with and is electrically connected to another electrode of the battery.

### Advantageous Effects of Invention

According to an embodiment of the present invention, an electronic key that suppresses conduction problems between a battery and a circuit while having improved ease of assembly can be provided.

### BRIEF DESCRIPTION OF DRAWINGS

FIG. 1 is an exploded perspective view of an electronic key according to a first embodiment.

FIG. 2A is a top view of a housing of the electronic key according to the first embodiment.

FIG. 2B is a cross-sectional view seen from the direction of arrows and taken along a line II(b)-II(b) in FIG. 2A.

FIG. 2C is a bottom view of the housing.

FIG. 2D is a side view of a left side surface from which a battery is inserted.

FIG. 2E is a cross-sectional view seen from the direction of arrows and taken along a line II(e)-II(e) in FIG. 2C.

FIG. 2F is a top view of a board of a control circuit unit.

FIG. 3A is a rear view of a battery terminal of the electronic key according to the first embodiment.

FIG. 3B is a left side view of the battery terminal.

FIG. 3C is a top view of the battery terminal.

FIG. 3D is a right side view of the battery terminal.

FIG. 3E is a front view of the battery terminal.

FIG. 3F is a perspective view of the control circuit unit and the battery terminal housed in a battery housing portion.

FIG. 3G is a top view of the control circuit unit and the battery terminal.

FIG. 4A is a bottom view of the battery terminal and the like after assembly.

FIG. 4B is a cross-sectional view, taken along a line IV-IV in FIG. 4A, illustrating a step in an assembly process.

FIG. 4C is a cross-sectional view, taken along the line IV-IV in FIG. 4A, illustrating a step in the assembly process.

FIG. 4D is a cross-sectional view, taken along the line IV-IV in FIG. 4A, illustrating a step in the assembly process.

FIG. 4E is a cross-sectional view, taken along the line IV-IV in FIG. 4A, illustrating a step in the assembly process.

FIG. 5A is a perspective view illustrating a step in the process of incorporating the battery terminal and the like of the electronic key according to the first embodiment.

FIG. 5B is a perspective view illustrating a step in the assembly process.

FIG. 5C is a perspective view illustrating a step in the assembly process.

FIG. 5D is a perspective view illustrating a step in the assembly process.

FIG. 5E is a perspective view illustrating a step in the assembly process.

FIG. 5F is a perspective view illustrating a step in the assembly process.

FIG. 6A is an exploded perspective view of a module of an electronic key according to a second embodiment.

FIG. 6B is a perspective view illustrating the module from above.

FIG. 6C is a perspective view illustrating the module from below.

### DESCRIPTION OF EMBODIMENTS

### Overview of Embodiments

An electronic key according to embodiments includes: a housing including a battery housing portion that houses a battery, the battery housing portion being provided in the housing; a battery terminal, arranged within the battery housing portion, that makes contact with one electrode of the battery housed within the battery housing portion; and a board, arranged within the battery housing portion, including a first conductive portion that makes contact with the battery terminal and is electrically connected to the one electrode of the battery via the battery terminal, and a second conductive portion that makes contact with and is electrically connected to another electrode of the battery.

### First Embodiment

### Overall Configuration of Electronic Key 1

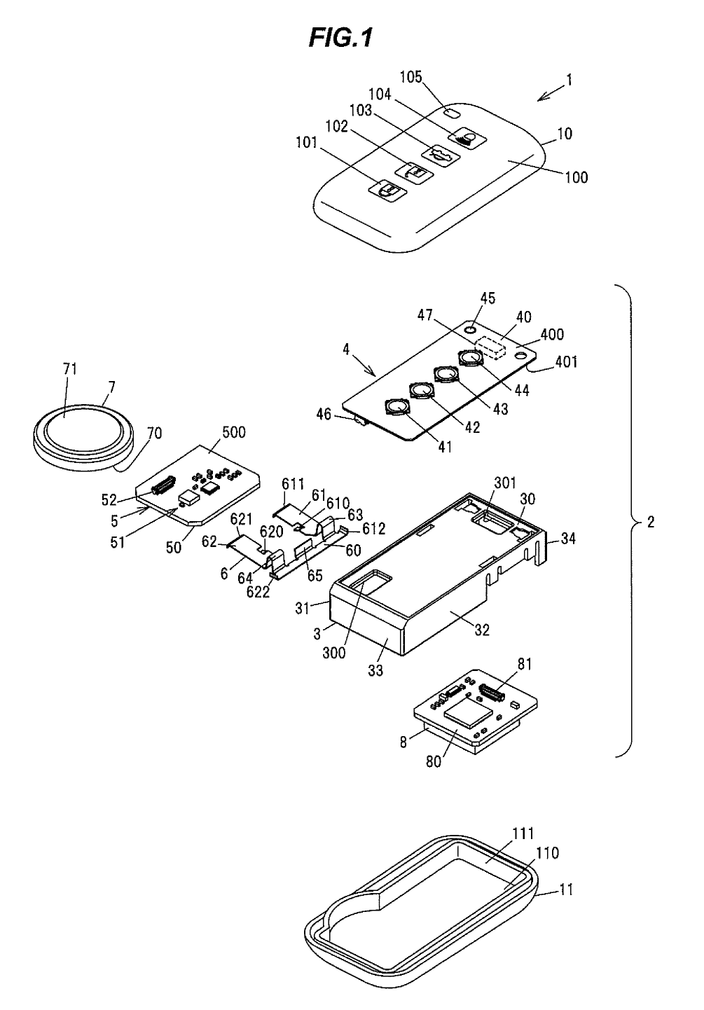

FIG. 1 is an exploded perspective view of an electronic key according to a first embodiment. In the drawings associated with the following embodiment, ratios between elements in the drawings may be different from the actual ratios. This electronic key 1 is, for example, a portable device capable of wirelessly instructing a door of a vehicle to lock and unlock, an engine of the vehicle to start, and the like. The electronic key 1 according to the present embodiment verifies an ID through two-way communication with the vehicle. When the ID is successfully verified, the person carrying the electronic key 1 can carry out actions such as locking and unlocking a door of the vehicle. The electronic key 1 is not limited to a vehicle, and may be used to lock and unlock the front door of a house or remotely operate an electronic device, for example.

As illustrated in FIG. 1, in the electronic key 1, a first button 101 to a fourth button 104 are arranged on an upper surface 100 of an upper case 10. The first button 101 to fourth button are configured to be capable of push operations, for example.

The upper case 10 is configured so as to be integrated with a lower case 11. As illustrated in FIG. 1, the electronic key 1 is configured so that a module 2 is housed within the upper case 10 and the lower case 11.

As illustrated in FIG. 1, the electronic key 1 includes: a housing 3 including a battery housing portion 37 that houses a battery 7, the battery housing portion 37 being provided in the housing; a battery terminal 6, arranged within the battery housing portion 37, that makes contact with one electrode of the battery 7 housed therein; and a board 50 serving as a base member arranged within the battery housing portion 37. A first conductive portion (described later) that makes contact with the battery terminal 6 and is electrically connected to the one electrode of the battery 7 via the battery terminal 6, and a second conductive portion (described later) that makes contact with and is electrically connected to the other electrode of the battery 7, are provided on the board 50.

### Configuration of Upper Case 10 and Lower Case 11

The upper case 10 and the lower case 11 are formed using a synthetic resin such as acrylonitrile butadiene styrene copolymer (ABS) resin or polycarbonate (PC) resin.

An operating light 105, for example, is arranged in the upper case 10 in addition to the first button 101 to the fourth button 104. The first button 101 to the fourth button 104 are configured to turn a first switch 41 to a fourth switch 44 of the module 2 (described later) on in response to a push operation that has been made. The operating light 105 outputs light from a light source 45 of the module 2 (described later) in response to the push operation. An operator recognizes that an operation has been accepted by the light outputted from the operating light 105.

As illustrated in FIG. 1, the lower case 11 has, in an inside base surface 110, a housing portion 111 having a shape corresponding to the module 2. The housing portion 111 houses the module 2 and holds the module 2 along with the upper case 10. The housing portion 111 includes a recess, formed therein, corresponding to the shape of the battery 7 incorporated into the module 2. The battery 7 is a button-type battery having a disk shape. An upper portion of the battery 7 corresponds to a positive electrode 70, and a lower portion of the battery 7 that has a smaller radius than that of the positive electrode 70 corresponds to a negative electrode 71.

The battery 7 is not limited to a button-type battery, and as a modified example, the battery 7 may be a secondary battery. In the case of a secondary battery, for example, an extended function unit 8 (described later) that enables the secondary battery to be charged in a non-contact manner, or an extended function unit 8 that enables the secondary battery to be charged via a cable, is added to the electronic key 1.

The electronic key 1 may be configured to contain a physical key for situations where the module 2 has become unable to communicate with the vehicle. The physical key is, for example, arranged between the housing portion 111, and the upper and lower cases 10 and 11.

### Overall Configuration of Module 2

The module 2 includes the housing 3, an interface unit 4, a control circuit unit 5, the battery terminal 6, the battery 7, and the extended function unit 8. The interface unit 4, the control circuit unit 5, the battery terminal 6, the battery 7, and the extended function unit 8 are housed within the housing 3 in an integrated manner.

### Configuration of Housing 3

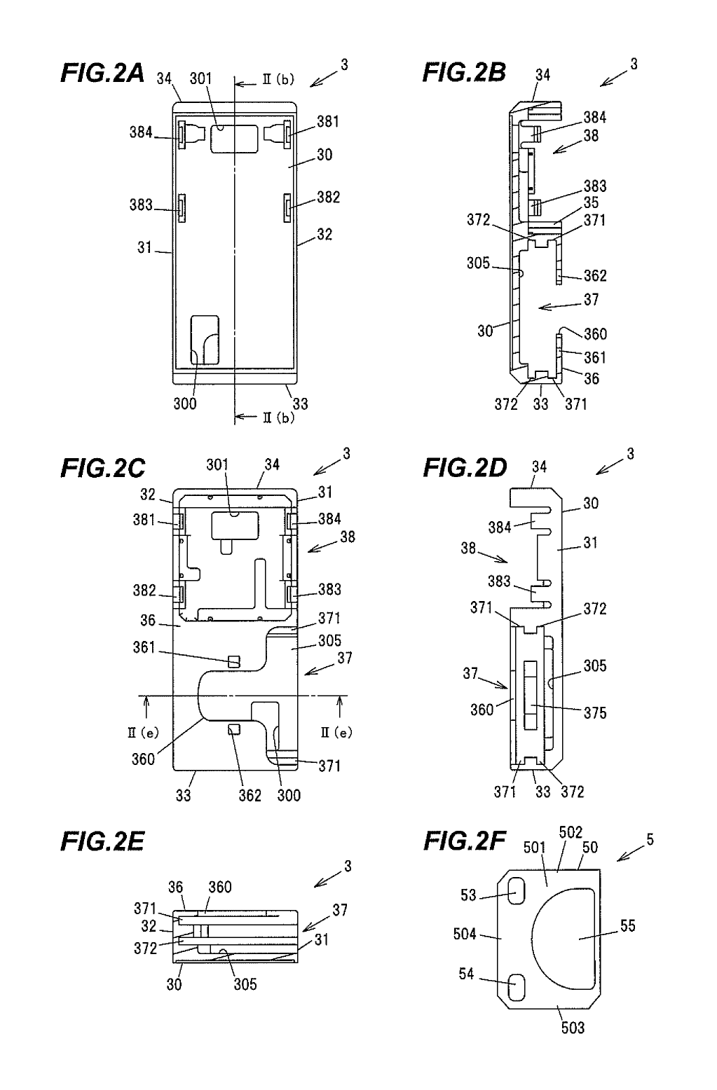

FIG. 2A is a top view of the housing of the electronic key according to the first embodiment, FIG. 2B is a cross-sectional view seen from the direction of arrows and taken along a line II(b)-II(b) in FIG. 2A, FIG. 2C is a bottom view of the housing, FIG. 2D is a side view of a left side surface from which the battery is inserted, FIG. 2E is a cross-sectional view seen from the direction of arrows and taken along a line II(e)-II(e) in FIG. 2C, and FIG. 2F is a top view of a board of the control circuit unit.

The housing 3 is formed using a synthetic resin such as ABS resin or PC resin, for example. As illustrated in FIGS. 1 and 2A, the interface unit 4 is arranged on an arrangement surface 30 of the housing 3 formed as a rectangular recess in the upper surface of the housing 3.

Additionally, as illustrated in FIG. 2B, the battery housing portion 37 is provided on a front surface 33 side of the housing 3, and a board housing portion 38 is provided on a rear surface 34 side of the housing 3, with a wall 35 of the housing 3 serving as a boundary between these portions.

The arrangement surface 30 includes a rectangular connector opening 300 and a rectangular connector opening 301. The connector opening 300 and the connector opening 301 are, for example, arranged such that long-side directions thereof are at 90° angles relative to each other. The connector opening 300 is provided on the battery housing portion 37 side, whereas the connector opening 301 is provided on the board housing portion 38 side.

As illustrated in FIGS. 2C and 2E, the battery housing portion 37 is open on a left side surface 31. Terminal holding grooves 371 serving as first guide grooves that guide the insertion of the battery terminal 6 and board holding grooves 372 serving as second guide grooves that guide the insertion of the board 50 are provided on opposing side surfaces. These opposing side surfaces are side surfaces of the wall 35 and the front surface 33 and located on the battery housing portion 37 sides of the wall 35 and the front surface 33.

Additionally, in the battery housing portion 37, a recess part 305 that houses a connector 52 and the like arranged on the board 50 is provided on the arrangement surface 30 side, and a recess part 375 conforming to the outer shape of the battery 7 is provided on a right side surface 32 side.

A removal recess part 360 recessed in a direction in which the battery 7 is removed is formed in a bottom surface 36 of the battery housing portion 37 so that the battery 7 housed within the battery housing portion 37 can be removed easily. As illustrated in FIG. 2C, a rectangular cutout hole 361 and a rectangular cutout hole 362 are formed on both sides of the removal recess part 360. The cutout hole 361 and the cutout hole 362 are provided so that a projecting portion 610 and a projecting portion 620 of the battery terminal 6 (described later) are fitted into the cutout hole 361 and the cutout hole 362 when the battery 7 is housed within the battery housing portion 37. The projecting portion 610 and the projecting portion 620 being fitted into the cutout hole 361 and the cutout hole 362 prevents the battery terminal 6 from being pulled out from the battery housing portion 37.

The above-described connector opening 300 is provided in the battery housing portion 37. The connector 52 of the board 50 of the control circuit unit 5 (described later) is connected to a connector 46 of the interface unit 4 via the connector opening 300.

A board 80 of the extended function unit 8 is housed within the board housing portion 38. A first pawl portion 381 to a fourth pawl portion 384 are provided, clockwise in the plane in FIG. 2A, in the board housing portion 38. The first pawl portion 381 and the second pawl portion 382 are arranged in a row, and the third pawl portion 383 and the fourth pawl portion 384 are arranged in a row. The first pawl portion 381 opposes the fourth pawl portion 384, and the second pawl portion 382 opposes the third pawl portion 383. Side surface parts of the board 80 are fitted with the first pawl portion 381 to fourth pawl portion 384, and the board 80 is held as a result.

The above-described connector opening 301 is provided in the board housing portion 38. A connector 81 of the board 80 is connected to a connector 47 of the interface unit 4 via the connector opening 301.

### Configuration of Interface Unit 4

The interface unit 4 is constituted of, for example, accepting means that accepts operations from an operator, indicating means that indicates the acceptance of an operation, and the like. Specifically, the interface unit 4 is configured including a light source, a switch, a touch sensor, a display, a microphone, a speaker, a camera, a photovoltaic panel, or the like, for example.

The interface unit 4 according to the present embodiment includes, for example, the first switch 41 to the fourth switch 44 and the light source 45 on a front surface 400 of a board 40. Additionally, in the interface unit 4, the connector 46 and the connector 47 are provided on a back surface 401 side of the board 40.

The board 40 of the interface unit 4 is, for example, a printed wiring board having a long, narrow, rectangular shape. The board 40 has a shape corresponding to the arrangement surface 30 of the housing 3.

The first switch 41 to the fourth switch 44 are, for example, surface-mounted microswitches. The first switch 41 to the fourth switch 44 are arranged in a row so as to correspond to the arrangement of the first button 101 to the fourth button 104 in the upper case 10.

The first switch 41 turns on in response to a push operation made on the first button 101, and this locks a door of the vehicle, for example. The second switch 42 turns on in response to a push operation made on the second button 102, and this unlocks the door of the vehicle, for example. The third switch 43 turns on in response to a push operation made on the third button 103, and this opens the trunk of the vehicle, for example. The fourth switch 44 turns on in response to a push operation made on the fourth button 104, and this causes the vehicle to sound an alarm, for example.

Switch signals outputted from the first switch 41 to the fourth switch 44 are outputted to the control circuit unit 5 via the connector 46, for example. The control circuit unit 5 generates a transmission signal to be transmitted to the vehicle in response to the inputted switch signal, and wirelessly outputs the transmission signal to the vehicle.

The light source 45 is constituted of a light-emitting element, for example. The light source 45 is configured such that current is supplied from the battery 7 to the light source 45 via the connector 52 and the connector 46 when the first switch 41 to the fourth switch 44 turn on, and the light source 45 emits light.

### Configuration of Control Circuit Unit 5

As illustrated in FIGS. 1 and 2F, the control circuit unit 5 includes the board 50, a control circuit 51, the connector 52, a first positive terminal 53 and a second positive terminal 54 serving as the first conductive portion, and a negative terminal 55 serving as the second conductive portion.

The board 50 is a rectangular printed wiring substrate, for example. The control circuit 51 and the connector 52 are arranged on an arrangement surface 500 of the board 50. The first positive terminal 53, the second positive terminal 54, and the negative terminal 55 are arranged on a terminal surface 501 corresponding to the back surface of the arrangement surface 500 of the board 50.

The control circuit 51 is constituted of a controller including a central processing unit (CPU) and the like, a communicator that wirelessly communicates with the vehicle, and the like, for example. The control circuit 51 is electrically connected to the first positive terminal 53, the second positive terminal 54, and the negative terminal 55, and is furthermore electrically connected to the connector 52.

The first positive terminal 53, the second positive terminal 54, and the negative terminal 55 are formed in plate shapes from an electrically conductive metal material such as copper or an alloy material containing such a metal material, for example. Note that a configuration is possible in which only one of the first positive terminal 53 and the second positive terminal 54 is provided on the control circuit unit 5, or a terminal obtained by forming the first positive terminal 53 and the second positive terminal 54 as a continuous entity may be provided.

### Configuration of Battery Terminal 6

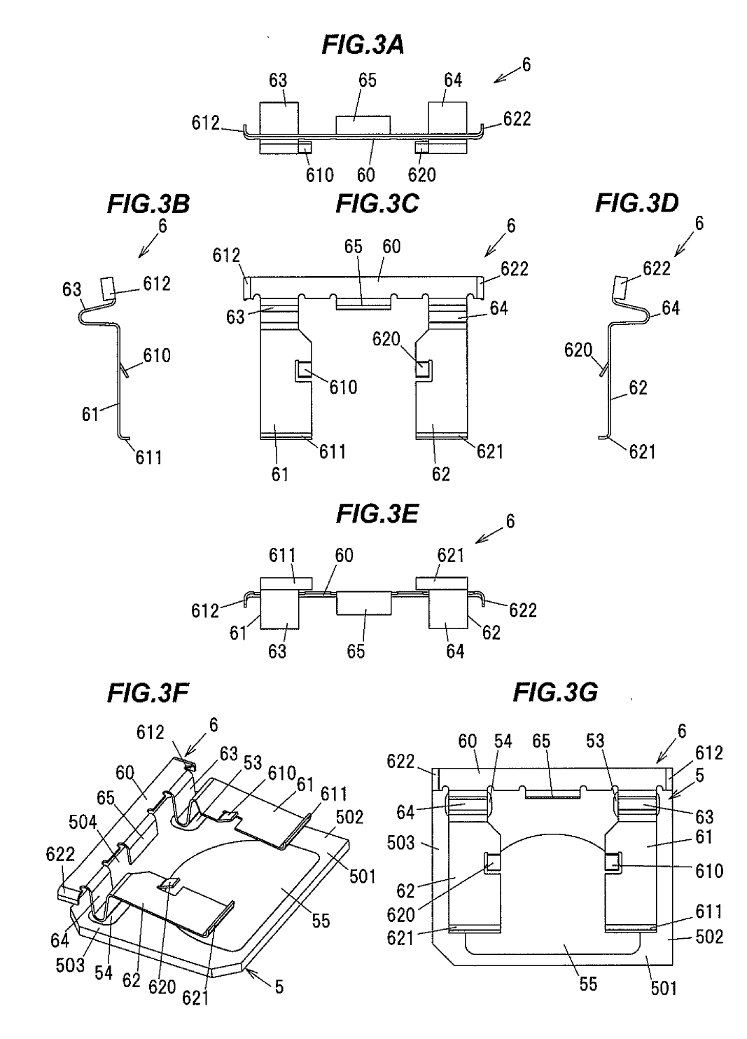

FIG. 3A is a rear view of the battery terminal of the electronic key according to the first embodiment, FIG. 3B is a left side view of the battery terminal, FIG. 3C is a top view of the battery terminal, FIG. 3D is a right side view of the battery terminal, FIG. 3E is a front view of the battery terminal, FIG. 3F is a perspective view of the control circuit unit and the battery terminal housed in the battery housing portion, and FIG. 3G is a top view of the control circuit unit and the battery terminal.

The battery terminal 6 is formed from an electrically conductive metal material such as copper or an alloy material containing such a metal material, for example.

As illustrated in FIGS. 3A to 3E, the battery terminal 6 includes: a base portion 60 that is longer in a direction intersecting with the insertion direction of the battery 7; a first terminal 61 serving as a first arm portion and a second terminal 62 serving as a second arm portion, extending from both ends of the base portion 60 in the direction opposite from the insertion direction, and making contact with one of the electrodes of the inserted battery 7; and a curved portion 63 serving as a first curved portion and a curved portion 64 serving as a second curved portion, provided on the first terminal 61 and the second terminal 62, respectively, and curving toward the board 50, such that at least one of the curved portions makes contact with the above-described first conductive portion of the board 50.

The base portion 60 includes a support portion 65, a guide portion 612, and a guide portion 622. The support portion 65 is provided in the center of the base portion 60, on the side surface thereof on which the first terminal 61 and the second terminal 62 are located. The support portion 65 is formed by bending a part projecting from the side surface in the same direction as the curved portion 63 and the curved portion 64. The support portion 65 suppresses deformation in the base portion 60 caused by the battery 7 being inserted or the like, for example.

As illustrated in FIG. 3E, the guide portion 612 is formed by bending an end part of the base portion 60 on the first terminal 61 side thereof in the same direction as the curved portion 63. The guide portion 612 is inserted into the terminal holding groove 371 on the wall 35 side of the battery housing portion 37.

As illustrated in FIG. 3E, the guide portion 622 is formed by bending an end part of the base portion 60 on the second terminal 62 side thereof in the same direction as the curved portion 64. The guide portion 622 is inserted into the terminal holding groove 371 on the front surface 33 side of the battery housing portion 37.

As illustrated in FIG. 3C, in the first terminal 61, the curved portion 63 is provided on the base portion 60 side, and a distal end portion 611 is provided on the opposite side therefrom. Additionally, the projecting portion 610, serving as a first projecting portion that projects in a direction opposite from the direction of contact with the battery 7, is provided in the first terminal 61.

As illustrated in FIG. 3B, the curved portion 63 is formed by bending the first terminal 61 on the base portion 60 side in a substantially elliptical shape. As illustrated in FIGS. 3F and 3G, an elastic force caused by deformation is produced when the control circuit unit 5, the battery terminal 6, and the battery 7 are housed in the battery housing portion 37, and as a result, the curved portion 63 makes contact with the first positive terminal 53 of the board 50. This elastic force ensures contact pressure between the curved portion 63 and the first positive terminal 53.

As will be described later, the first terminal 61 makes contact with the positive electrode 70 of the inserted battery 7, and thus the first positive terminal 53 is electrically connected to the positive electrode 70 via the battery terminal 6.

As illustrated in FIGS. 3B and 3C, the projecting portion 610 is formed by bending a part of the first terminal 61, on the inner side of the shorter direction thereof, with the part of the projecting portion 610 located on the curved portion 63 side serving as a base point. To be more specific, as illustrated in FIG. 3B, the projecting portion 610 is formed by bending a part of the projecting portion 601 on a side opposite from the curved portion 63, or in other words, the distal end portion 611 side, toward the bottom surface 36 of the housing 3.

The distal end portion 611 is formed by bending a distal end of the first terminal 61 in the same direction as the projecting portion 610. The distal end portion 611 is provided to make it easy to insert the battery 7.

As illustrated in FIG. 3D, in the second terminal 62, the curved portion 64 is provided on the base portion 60 side, and a distal end portion 621 is provided on the opposite side therefrom. Additionally, the projecting portion 620, serving as a second projecting portion that projects in a direction opposite from the direction of contact with the battery 7, is provided in the second terminal 62.

As illustrated in FIG. 3D, the curved portion 64 is formed by bending the second terminal 62 on the base portion 60 side in a substantially elliptical shape. As illustrated in FIGS. 3F and 3G, an elastic force caused by deformation is produced when the control circuit unit 5, the battery terminal 6, and the battery 7 are housed in the battery housing portion 37, and as a result the curved portion 64 makes contact with the second positive terminal 54 of the board 50. This elastic force ensures contact pressure between the curved portion 64 and the second positive terminal 54.

As will be described later, the second terminal 62 makes contact with the positive electrode 70 of the inserted battery 7, and thus the second positive terminal 54 is electrically connected to the positive electrode 70 via the battery terminal 6.

As illustrated in FIGS. 3C and 3D, the projecting portion 620 is formed by bending a part of the second terminal 62, on the inner side of the shorter direction thereof, with the part of the projecting portion 620 located on the curved portion 64 side serving as a base point. To be more specific, as illustrated in FIG. 3D, the projecting portion 620 is formed by bending a part of the projecting portion 620 on the side opposite from the curved portion 64, or in other words, the distal end portion 621 side, toward the bottom surface 36 of the housing 3.

The distal end portion 621 is formed by bending a distal end of the second terminal 62 in the same direction as the projecting portion 620. Like the distal end portion 611, the distal end portion 621 is provided to make it easy to insert the battery 7.

The incorporation of the control circuit unit 5, the battery terminal 6, and the battery 7 will be described next.

### INCORPORATION OF BATTERY TERMINAL AND THE LIKE

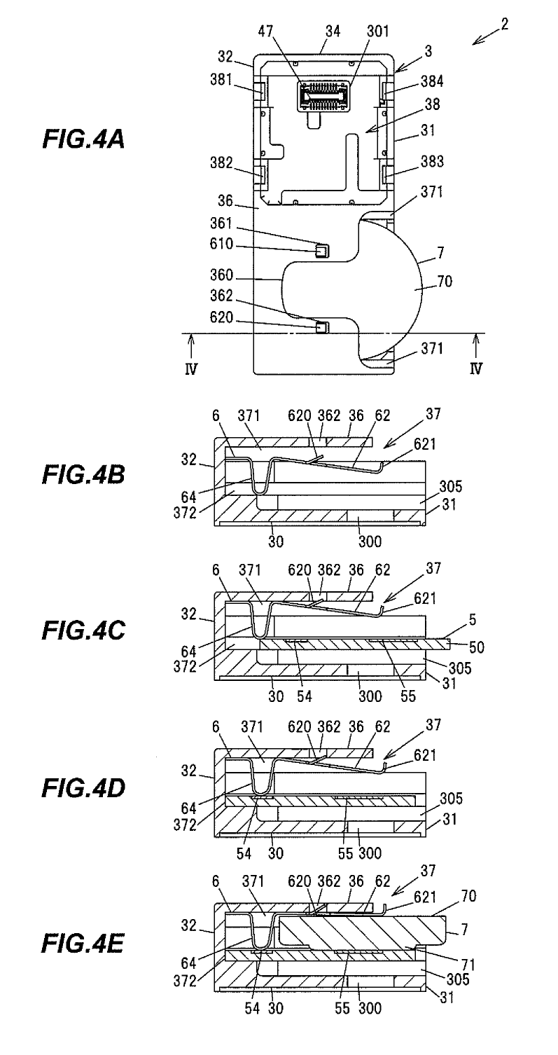

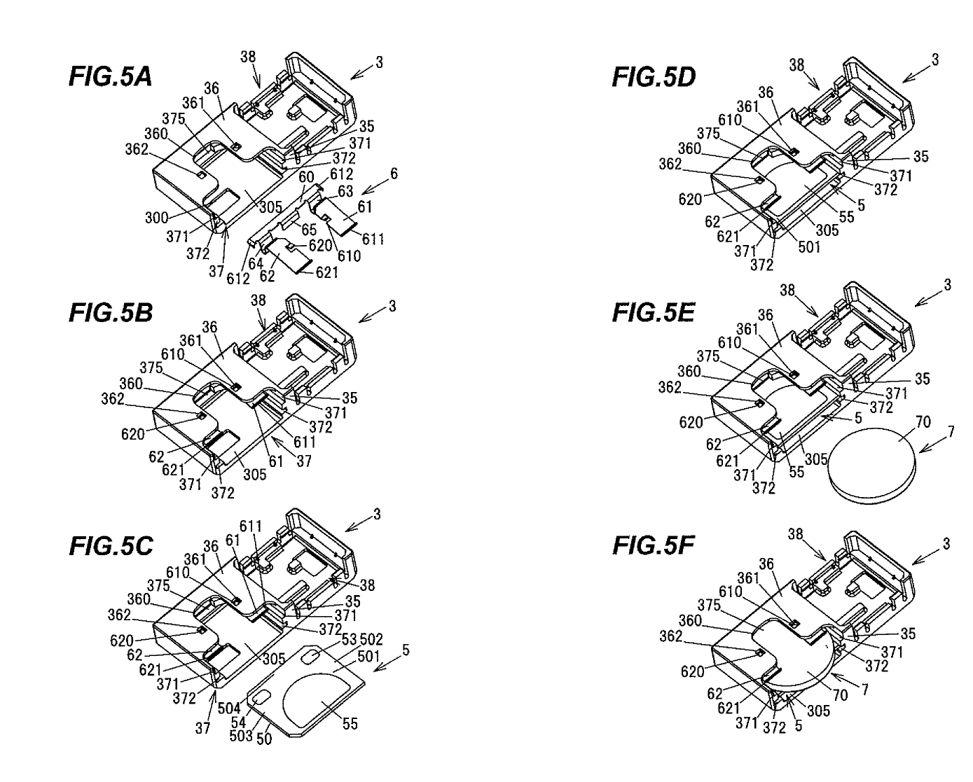

FIG. 4A is a bottom view of the battery terminal and the like after assembly, and FIGS. 4B to 4E are cross-sectional views, taken along a line W-W in FIG. 4A, illustrating steps in an assembly process. FIGS. 5A to 5F are perspective views illustrating steps in the assembly process.

### Incorporation of Battery Terminal 6

First, as illustrated in FIGS. 5A and 5B, the guide portion 612 and the guide portion 622 of the battery terminal 6 are fitted into the terminal holding grooves 371 of the battery housing portion 37 in the housing 3, after which the battery terminal 6 is inserted into the battery housing portion 37 so that the battery terminal 6 is incorporated into the battery housing portion 37.

Specifically, when the guide portion 612 and the guide portion 622 are inserted into the terminal holding grooves 371, the groove spacing is smaller than the spacing between the guide portion 612 and the guide portion 622, and thus the guide portion 612 and the guide portion 622 deform inward. This deformation ensures that the guide portion 612 and the guide portion 622 remain in contact with the terminal holding grooves 371.

Because the guide portion 612 and the guide portion 622 are inserted into the terminal holding grooves 371, the position of the base portion 60 is held at the position of the guide portion 612 and the guide portion 622, as illustrated in FIG. 4B. In this state, the first terminal 61 and the second terminal 62 are suspended within the battery housing portion 37.

### Incorporation of Control Circuit Unit 5

Next, as illustrated in FIGS. 5C and 5D, an end portion 502 and an end portion 503 of the board 50 of the control circuit unit 5 are fitted into the board holding grooves 372 of the battery housing portion 37 so that the control circuit unit 5 is incorporated into the battery housing portion 37.

Specifically, when the board 50 is inserted into the battery housing portion 37, a distal end portion 504 of the board 50 makes contact with the curved portion 63 and the curved portion 64.

As illustrated in FIG. 4C, when the board 50 is inserted further along the board holding grooves 372, the curved portion 63 and the curved portion 64 deform under pressure from the distal end portion 504 of the board 50, and the first terminal 61 and the second terminal 62 are pushed in the upward direction in the plane in FIG. 4C.

As illustrated in FIG. 4D, when the board 50 is inserted even further along the board holding grooves 372 so that the board 50 is housed within the battery housing portion 37, the curved portion 63 makes contact with the first positive terminal 53 and the curved portion 64 makes contact with the second positive terminal 54. At this time, as illustrated in FIG. 4D, elastic force produced by the deformation of the curved portion 63 and the curved portion 64 causes the projecting portion 610 of the first terminal 61 to make contact with the cutout hole 361 in the battery housing portion 37, and causes the projecting portion 620 of the second terminal 62 to make contact with the cutout hole 362 in the battery housing portion 37.

### Incorporation of Battery 7

Next, as illustrated in FIGS. 5E and 5F, the battery 7 is inserted between the board 50 and the first and second terminals 61 and 62 so that the battery 7 is incorporated into the battery housing portion 37.

Specifically, when the battery 7 is inserted into the battery housing portion 37, first, the periphery of the battery 7 makes contact with the distal end portion 611 of the first terminal 61 and the distal end portion 621 of the second terminal 62. The battery 7 pushes the first terminal 61 and the second terminal 62 upward via the distal end portion 611 and the distal end portion 621. When the battery 7 is inserted further into the battery housing portion 37 and the battery 7 is housed within the battery housing portion 37, the first terminal 61 and the second terminal 62 are pushed further upward. As a result, the projecting portion 610 fits with the cutout hole 361 and the projecting portion 620 fits with the cutout hole 362, as illustrated in FIG. 4E.

Additionally, as illustrated in FIG. 4E, when the battery 7 is housed within the battery housing portion 37, the positive electrode 70 of the battery 7 makes contact with the first terminal 61 and the second terminal 62, and the negative electrode 71 of the battery 7 makes contact with the negative terminal 55 of the board 50. The first terminal 61 and the second terminal 62 produce an elastic force when the battery 7 is sandwiched between the board 50 and the first and second terminals 61 and 62. This elastic force maintains contact between the positive electrode 70 and the first and second terminals 61 and 62, and maintains contact between the negative electrode 71 and the negative terminal 55.

As a result of this incorporation, the positive electrode 70 of the battery 7 is electrically connected to the first positive terminal 53 and the second positive terminal 54 of the board 50 via the battery terminal 6, the negative electrode 71 of the battery 7 is electrically connected to the negative terminal 55 of the board 50, and the battery 7 is electrically connected to the control circuit 51.

### Effects of the First Embodiment

The electronic key 1 according to the present embodiment can suppress conduction problems between the battery 7 and the control circuit 51, and can improve the ease of assembly. Specifically, according to the electronic key 1, the battery terminal 6, the control circuit unit 5, and the battery 7 are housed within the battery housing portion 37 of the housing 3 of the module 2. This ensures conduction between the battery 7 and the control circuit 51 of the control circuit unit 5, and this in turn makes it possible to suppress conduction problems between the battery 7 and the control circuit 51 and improve the ease of assembly as compared to a case where the terminals are fixed to the board using solder or the like.

The electronic key 1 does not require a member that sandwiches the board from both sides in order to ensure contact pressure between the battery and the terminals provided on the board. The electronic key 1 thus has a low number of components and reduced manufacturing costs.

According to the electronic key 1, the battery 7 can be assembled by housing the battery terminal 6 and the control circuit unit 5 within the battery housing portion 37, and thus the assembly is easier than in a case where the terminals are assembled with the board.

According to the electronic key 1, the extended function unit 8 can be replaced, and thus the electronic key 1 can be applied flexibly in electronic keys having different specifications.

### Second Embodiment

A second embodiment differs from the first embodiment in that the housing 3 includes only the battery housing portion 37.

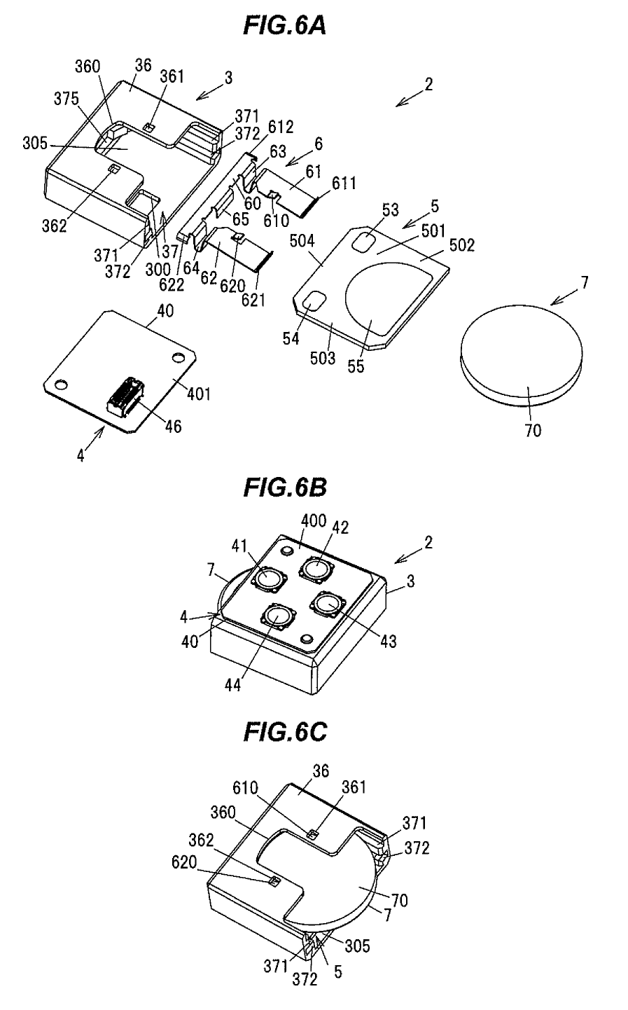

FIG. 6A is an exploded perspective view of a module of an electronic key according to the second embodiment, FIG. 6B is a perspective view illustrating the module from above, and FIG. 6C is a perspective view illustrating the module from below. In the embodiment described below, parts having the same functions and configurations as in the first embodiment will be given the same reference numerals as in the first embodiment, and descriptions thereof will be omitted.

As illustrated in FIGS. 6A to 6C, of the battery housing portion 37 and the board housing portion 38, the module 2 according to the second embodiment includes only the battery housing portion 37.

The board 40 of the interface unit 4 in this module 2 has a shape conforming to the housing 3. As illustrated in FIG. 6B, in the interface unit 4, the first switch 41 to the fourth switch 44 are arranged on the board 40 so as to be positioned at the four end points of a plus sign shape.

Accordingly, the electronic key 1 can be made smaller in the case where, for example, it is not necessary to extend the functions beyond the functions assigned to the buttons provided in the electronic key 1.

Although several embodiments of the present invention and a modified example thereof have been described above, these embodiments and modified example are merely examples, and the invention according to claims is not intended to be limited thereto. Such novel embodiments and modification can be implemented in various other forms, and various omissions, substitutions, changes, and the like can be made without departing from the spirit and scope of the present invention. In addition, all combinations of the features described in these embodiments and modified example are not necessary to solve the problem. Furthermore, these embodiments and modified example are included within the spirit and scope of the invention and also within the scope of the invention described in the claims and equivalents thereof.

### INDUSTRIAL APPLICABILITY

The present invention can be applied in an electronic key having a housing in which a battery housing portion that houses a battery is provided.

### REFERENCE SIGNS LIST

1 ELECTRONIC KEY
3 HOUSING
6 BATTERY TERMINAL
7 BATTERY
37 BATTERY HOUSING PORTION
50 BOARD
53 FIRST POSITIVE TERMINAL
54 SECOND POSITIVE TERMINAL
55 NEGATIVE TERMINAL
60 BASE PORTION
61 FIRST TERMINAL
62 SECOND TERMINAL
63 CURVED PORTION
64 CURVED PORTION
371 TERMINAL HOLDING GROOVE
372 BOARD HOLDING GROOVE
610 PROJECTING PORTION
620 PROJECTING PORTION

1. An electronic key, comprising:
a housing comprising a battery housing portion that houses a battery, the battery housing portion being provided in the housing;
a battery terminal, arranged within the battery housing portion, that makes contact with one electrode of the battery housed within the battery housing portion; and
a board, arranged within the battery housing portion, comprising a first conductive portion that makes contact with the battery terminal and is electrically connected to the one electrode of the battery via the battery terminal, and a second conductive portion that makes contact with and is electrically connected to another electrode of the battery.

2. The electronic key according to claim 1, wherein the battery terminal comprises:
a base portion that is elongated in a direction intersecting with an insertion direction of the battery;
a first arm portion and a second arm portion that each extend from both ends of the base portion in a direction opposite from the insertion direction and make contact with the one electrode of the battery that is inserted; and
a first curved portion and a second curved portion that are provided on the first arm portion and the second arm portion, respectively, and are curved toward the board, at least one of the first curved portion and the second curved portion making contact with the first conductive portion of the board.

3. The electronic key according to claim 2, wherein the first arm portion and the second arm portion comprise a first projecting portion and a second projecting portion, respectively, that project on a side opposite from a side of contacting with the battery, and
wherein the battery housing portion comprises a first hole and a second hole into which the first projecting portion and the second projecting portion are inserted by the insertion of the battery.

4. The electronic key according to claim 1, wherein the battery housing portion comprises, in opposite side surfaces, first guide grooves that guide insertion of the battery terminal.

5. The electronic key according to claim 1, wherein the battery housing portion comprises, in opposite side surfaces, second guide grooves that guide insertion of the board.
